(19) United States
(12) Patent Application Publication
(10) Pub. No.: US 2025/0373489 A1
(43) Pub. Date: Dec. 4, 2025

(54) ADAPTIVE NETWORK SLICING

(71) Applicant: Apple Inc., Cupertino, CA (US)

(72) Inventors: Sarma V. Vangala, Campbell, CA (US); Ajoy K. Singh, Milpitas, CA (US); Babar Qaisrani, San Ramon, CA (US); Erdogan Dede, San Diego, CA (US)

(73) Assignee: Apple Inc., Cupertino, CA (US)

(21) Appl. No.: 18/680,623

(22) Filed: May 31, 2024

(51) Int. Cl. H04L 41/0806; H04L 41/0895; H04L 41/40; H04W 40/24; H04W 48/18

(52) U.S. Cl. CPC H04L 41/0806; H04L 41/0895; H04L 41/40; H04W 48/18; H04W 40/24

(57) ABSTRACT

The present application relates to adaptive network slicing. In an example, a device acts as an intermediate node between a plurality of end devices and a cellular network. The device can store slice configuration information for an adaptable slice. The adaptable slice can support one or more service types and can be configured for the device and established with the cellular network. Based on the slice configuration information, the device can manage use of the adaptable slice by the end devices. Particularly, the device can route slice traffic to and/or from each one of the end devices by using the adaptable slice. As needed, the device can signal the network to update a configuration or slice properties of the adaptable slice.

Cellular communications can be defined in various standards to enable communications between a user equipment and a cellular network. For example, Fifth generation mobile network (5G) is a wireless standard that aims to improve upon data transmission speed, reliability, availability, and more. Different services can be provided via the cellular network. Each one of such services may be subject to a particular quality of service (QOS) performance.

### BRIEF DESCRIPTION OF THE DRAWINGS

FIG. 1 illustrates a network environment, in accordance with some embodiments.

FIG. 2 illustrates an example of non-adaptive network slicing, in accordance with some embodiments.

FIG. 3 illustrates an example of adaptive network slicing, in accordance with some embodiments.

FIG. 4 illustrates an example of adaptive network slicing that is based on pre-associations between end devices and slices, in accordance with some embodiments.

FIG. 5 illustrates an example of adaptive network slicing that dynamically allocates end devices to slices, in accordance with some embodiments.

FIG. 6 illustrates an example of adaptive network slicing that dynamically allocates end devices to portions of a slice, in accordance with some embodiments.

FIG. 7 illustrates an example of signaling between an intermediate device and a network for adaptive slicing, in accordance with some embodiments.

FIG. 8 illustrates an example of a static configuration for adaptive network slicing, in accordance with some embodiments.

FIG. 9 illustrates an example of user equipment routing selection Policy (URSP) rules for adaptive network slicing, in accordance with some embodiments.

FIG. 10 illustrates an example of an operational flow/algorithmic structure for adaptive network slicing, in accordance with some embodiments.

FIG. 11 illustrates an example of a device, in accordance with some embodiments.

### DETAILED DESCRIPTION

Embodiments of the present disclosure are directed to, among other things, adaptive network slicing. In an example, a first device (which may be referred to herein as an intermediate device, a relay device, or an aggregator device) can be configured to use one or more slices. A slice can represent a logical network that can provide specific network capabilities and network characteristics. A plurality of devices (which may be referred to herein as end devices) can connect with the first device (e.g., as part of an ecosystem, where the first device and the end devices belong to the ecosystem and are associated with a same account). The first device can manage the use of the one or more slices for the plurality of devices such that slice traffic from and/or to each of such devices uses a slice of the one or more slices or a portion of the slice. Different options exist for configuring the one or more slices. In one option, a single slice configuration is defined with a parameter that enables “N” uses of the slice configuration. Upon an end device connecting to the first device, the first end device can activate a corresponding slice using the slice configuration. In another option, a same slice can be configured to support different slice configurations or different slices can be configured, where each supports a different slice configuration. These and other features are further described herein below.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processing circuitry” as used herein refers to, is part of, or includes circuitry capable of sequentially and automatically carrying out a sequence of arithmetic or logical operations, or recording, storing, or transferring digital data. The term “processing circuitry” may refer to an application processor, a baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The terms “device” and “user equipment (UE)” as used herein refers to a wired and/or wireless computing device with radio communication capabilities and that may use network resources in a communications network. The terms “device” and “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc.

The term “base station” as used herein refers to a device with radio communication capabilities, that is a network component of a communications network (or, more briefly, a network), and that may be configured as an access node in the communications network. A device's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “connected” may mean that two or more elements, at a common communication protocol layer, have an established signaling relationship with one another over a communication channel, link, interface, or reference point.

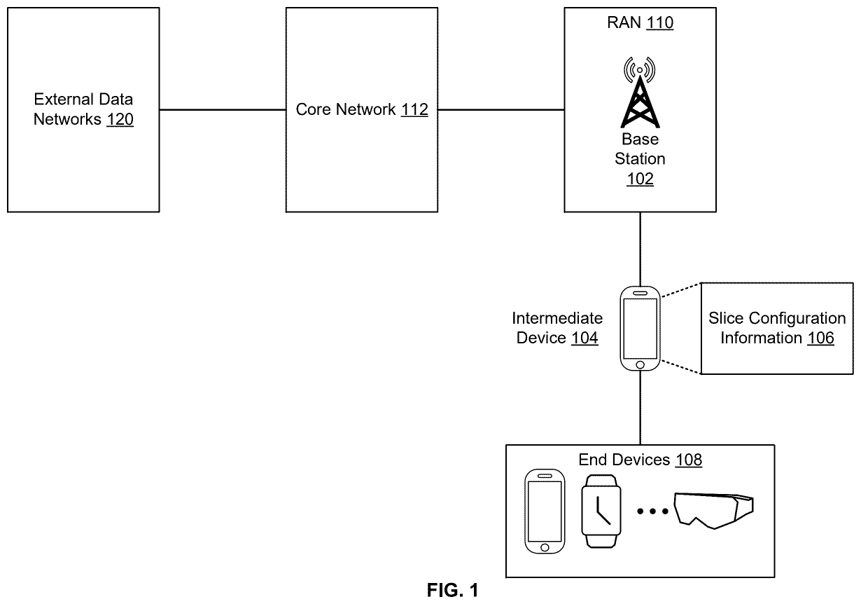

FIG. 1 illustrates a network environment, in accordance with some embodiments. The network environment may include an intermediate device 104 communicatively coupled with a base station 102 of a radio access network (RAN) 110. The intermediate device 104 and the base station 102 may communicate over air interfaces compatible with 3GPP Technical specifications (TSs) such as those that define a Fifth Generation (5G) new radio (NR) system or a later system. The base station 102 may provide user plane and control plane protocol terminations toward the intermediate device 104.

In some embodiments, the intermediate device 104 and base station 102 may establish data radio bearers (DRBs) to support transmission of data over a wireless link between the two nodes. In one example, these DRBs may be used for different types of slice traffic.

The network environment may further include a core network 112. For example, the core network 112 may comprise a 5^{th} Generation Core network (5GC) or later generation core network. The core network 112 may be coupled to the base station 102 via a fiber optic or wireless backhaul. The core network 112 may provide functions for the intermediate device 104 via the base station 102. These functions may include managing subscriber profile information, managing slices, authentication of services, or switching functions for voice and data sessions. The functions may also include communicatively coupling devices, such as the intermediate device 104, to one or more external data networks 120 that may be cellular networks (e.g., operated by other network operators than the network operator of the core network 112, and/or cellular networks that use different radio access technologies (RATs)) and non-cellular networks.

In an example, the core network 112 may include a core access and mobility management function (AMF). The AMF may include an instance of a 5G mobility management (5G MM) function associated with the intermediate device 104. In addition, the RAN 110 may also have a connection to the AMF. Thus, the 5G CN may support unified authentication over both connections as well as allow simultaneous registration for device access via the RAN 110 (e.g., via the base station 102 and a different access point (AP) of the RAN 110). In turn, the AMF may include one or more functional entities associated with the core network 112, such as a network slice selection function (NSSF), a short message service function (SMSF), an application function (AF), a unified data management (UDM), a policy control function (PCF), and/or an authentication server function (AUSF). Note that these functional entities may also be supported by a session management function (SMF) of the core network 112. The AMF may be in communication with the SMF a. Further, the base station 102 may be in communication with a user plane function (UPF) that may also be in communication with the SMF.

In some embodiments, the network environment may also include a number of end devices 108. The intermediate device 104 may act as a node between the RAN 110 (or the base station 102) and each one of the end devices 108 such that the access to the RAN 110 is provided via the intermediate device 104. The end devices 108 can also be referred to as endpoint devices or endpoints.

In an example, the intermediate device 104 and the end devices 108 can belong to an ecosystem that employs one or more device discovery protocols and communication protocols. For instance, the intermediate device 104 and the end devices 108 can form a smart home network. Generally, the intermediate device 104 and the end devices 108 can be associated with a same account (e.g., registered as being part of a same user or group account). It may be possible that the intermediate device 104 and the end devices 108 use the same operating system (OS), different OSs of a same OS provider, or different OSs of different OS providers.

The intermediate device 102 may be associated (e.g., registered) with a subscription at the core network 112. In an example, the subscription may be associated with the same account of the intermediate device 104 and may identify the intermediate device 104 and/or the account (e.g., by including a subscriber identity module (SIM) identifier associated with the intermediate device and/or by including an account identifier). The subscription may also, but need not, identify the end devices 108, the number of end devices 108, and/or the type of end devices 108. The subscription can indicate that one or more slices are requested and an arrangement for providing the one or more slices. For instance, the subscription can identify the intermediate device 104 and/or the account and service types to be provided, including service types to be supported by network slicing (e.g., enhanced mobile broadband (eMBB), ultra-reliable and low-latency communications (URLLC), mobile internet of things (MioT), vehicle to everything (V2X), high performance machine-type communication (HMTC), massive machine-type communication (mMTC), low latency personal hot spot (LLPHS), augmented reality virtual reality (ARVR), mixed reality (XR), etc.).

In an example, the subscription can be obtained and/or updated (e.g., to purchase a slice) using an out of band signal (e.g., via a web portal and/or a device upsell). Provisioning a slice can also involve using an out of band signal.

Based on the subscription, the core network 112 (e.g., a function thereof) can configure one or more slices for the intermediate device 104. In particular, the intermediate device 104 can receive and store slice configuration information 106 about the one or more slices. Based on the slice configuration information 106, the intermediate device 104 can manage the use of one or more slices by the end devices 108. In particular, a slice can be established between the intermediate device 104 and the network (e.g., between the intermediate device 104 and a function of the core network 112 via the base station 102). The same slice can be used for slice traffic sent from the end devices 108 to the network and/or from the network to the end devices 108. For brevity, slice traffic is referred to herein as traffic. Different options for configuring and using the slice are further described herein below. Generally, a slice can be referred to also as a network slice and can represent a logical network that provides specific network capabilities and network characteristics, and that can be dynamically defined. A device, such as the intermediate device 104, may access multiple slices over the same RAN 110. Each slice may serve a particular service type or multiple service types, each with an agreed upon service-level agreement (SLA). A slice can involve the core network 112 (or a portion thereof) and RAN network control plane and user network plane. The slice can be identified by a single network slice selection assistance information (S-NSSAI). The S-NSSAI may have network-specific values or have standard values that indicate a slice/service type (SST) and a slice differentiator (SD).

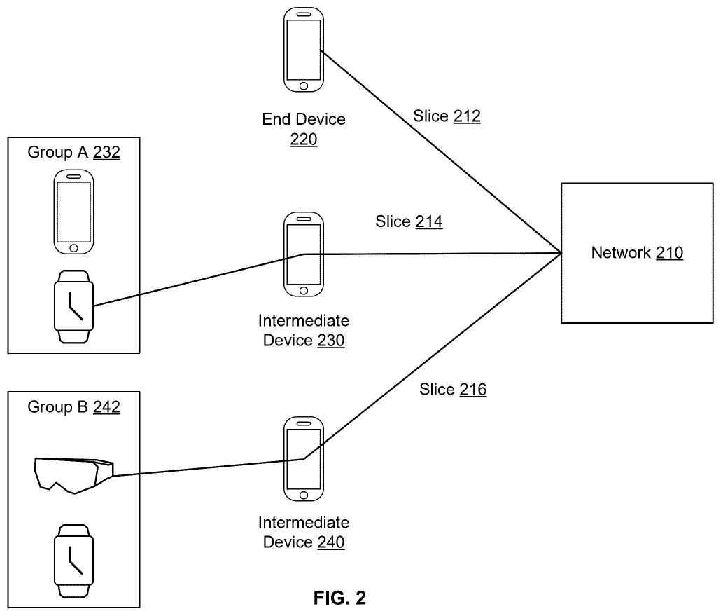

FIG. 2 illustrates an example of non-adaptive network slicing, in accordance with some embodiments. As illustrated, a plurality of devices can be associated with a same account (e.g., as part of a same smart home network). Slices between such devices and a network 210 can be configured. More particularly, a first slice 212 can be configured for an end device 220. A first intermediate device 230 can manage access of a group A 232 of end devices to the network. This access can include a second slice 214 configured to one of the end devices of the group A 232. Similarly, a second intermediate device 240 can manage access of a group B 242 of end devices to the network. This access can include a third slice 216 configured to one of the end devices of the group B 242.

Generally, the three slices 212, 214, and 216 are configured according to a subscription associated with the account. This subscription can be specific, whereby each of the slices 212, 214, and 216 is requested for the corresponding end device. Given this subscription, none of the intermediate devices 230 and 240 have control over the network slicing (including how each slice can be used, whether each slice can be re-allocated to a different end device, and whether the configuration of each slice can be dynamically changed, among other slice management functions).

As such, considering the first group A 232, the slice 214 is configured for a first end device (shown as a smart watch). Assume that a second end device of the first group A 232 (e.g., say a smart phone) is to also use a slice. In this case, the intermediate device 230 is incapable of establishing the slice for the second end device, re-use the existing slice 214 (e.g., when not being in use by the first end device), or change the configuration or use of the existing slice 214 (e.g., by changing a property of the slice 214, such as by adding a service type or altering the existing service type). Further, the first slice 212, at least during the time when it is being used by the end device 220, is unusable to the other end devices or the intermediate devices 230 and 240.

In other words, if a user of the subscription uses a different device for which no slice has been configured as part of the subscription, a new slicing agreement needs to be made for that specific device. Current agreements are not directly transferable from device to device. Although common agreements for multiple devices within a home ecosystem can be made, most devices can stay unused and simultaneous and/or random uses and pay-per-use cannot be easily achieved.

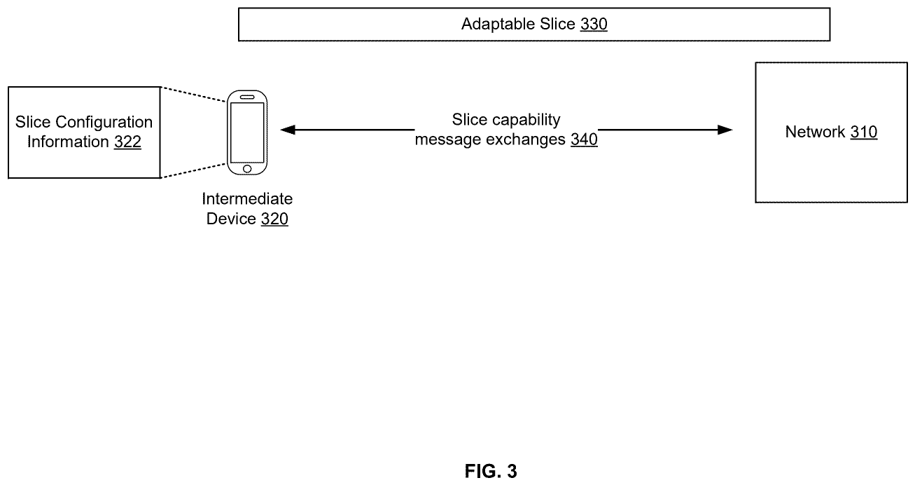

FIG. 3 illustrates an example of adaptive network slicing, in accordance with some embodiments. Here, an intermediate device 320 acts as a common hub that controls the experience of all end devices, where the end devices and, possibly, the intermediate device 320 belong to the same account. In a particular use case, the end devices can be any mobile device such as a wearable device, a mixed reality device, a spatial computing device, a tablet, a smartphone, etc. that may belong to an ecosystem (e.g., by using operating systems and protocols of the ecosystem), and/or any other non-ecosystem devices sharing the cellular radio functionalities, like a smart television. The intermediate device 320 can be one of the ecosystem or non-ecosystem devices such as a wearable device, a tablet, a smartphone, etc. In such a situation, with a cellular connection on the intermediate device 320, slicing per end device needs can be tied to the end device management performed by the intermediate device 320, while allowing the intermediate device 320 to make network slicing interchangeable across the end devices.

In an example, the intermediate device 320 stores slice configuration information 322 for an adaptable slice 330 configured for the intermediate device 320 with a network 310. The adaptable slice 330 is an example of a slice with the network 310 having a configuration that allows the intermediate device 320 to control or manage its usage or at least some of its properties. For example, the intermediate device 320 can perform different slice-related functions.

A first example of a slice-related function includes dynamically allocating the adaptable slice 330 to an end device and/or changing the allocation to another end device (without necessitating a change at the network 310 and/or signaling the allocation or re-allocation to the network 310). For instance, an eMBB slice can be allocated to a smartphone at a first point in time. At a second point in time, such as when eMBB slice is no longer used for traffic of the smartphone, the intermediate device 320 can allocate the eMBB slice to a tablet. At this point in time, traffic of the tablet can flow through the eMBB slice.

A second example of a slice-related function includes pre-configuring a plurality of slices (that form the adaptable slice 330), and activating one of the plurality of slices for an end device upon the end device establishing a connection with the intermediate device 320 (e.g., during an attachment procedure or a discovery procedure, whereby the connection is a wireless connection using a communication protocol, such as a WiFi protocol, a 3GPP NR protocol, or other protocols). For instance, two eMBB (possibly, a different number of eMBB slices and/or other service types) are configured. Upon the smartphone connecting to the intermediate device 320, the intermediate device 320 activates one of the eMBB slices for the smartphone. Upon the tablet connecting to the intermediate device 320, the intermediate device 320 activates the other eMBB slice for the tablet.

A third example of a slice-related function includes configuring and activating a slice of the adaptable slice 330 upon an end device establishing a connection with the intermediate device 320. Similar to the second example above, assume that the smartphone connects to the intermediate device 320. Here, however, during the attachment procedure or the discovery procedure, the intermediate device 320 can signal the network 310 to establish an eMBB slice with the network 310 and can allocate this slice to the smartphone.

A fourth example of a slice-related function includes deactivating or removing a slice of the adaptable slice 330 upon an end device no longer being connected with the intermediate device 320. Continuing with the above example of the smartphone, assume that the connection with the intermediate device 320 is terminated. Here, the intermediate device 320 can signal the network 310 to terminate or deactivate the eMBB slice.

A fifth example of a slice-related function includes allocating a portion or the entirety of a slice of the adaptable slice 330 to an end device and allocating that same portion or the entirety of the slice to another end device at a different time. Referring back to the smartphone and the tablet use case, assume an eMBB slice is configured. The intermediate device 320 can allocate the eMBB slice during a first time period to the smartphone and allocate the eMBB slice during a second time period to the tablet. For instance, as long as traffic of the smartphone is to be exchanged with the network 310, the eMBB slice can be allocated to the smartphone. Otherwise, the eMBB slice can be allocated to the tablet.

A sixth example of a slice-related function includes allocating a first portion of a slice of the adaptable slice 330 to an end device and allocating a second portion of the slice to another device, while the first portion is in use (e.g., enabling simultaneous use of portions of the slice by different end points). Referring back to the smartphone and the tablet use case, assume an eMBB slice is configured. The intermediate device 320 can allocate a bandwidth portion of the eMBB slice to the smartphone and allocate the remaining bandwidth portion to the tablet.

A seventh example of a slice-related function includes modifying one or more properties of a slice of the adaptable slice 330. For example, a service type can be added or removed from the slice, and/or a particular service level of the service type can be modified (e.g., a throughput of the slice can be increased or decreased). Generally, modifying a slice property can change a capability of the adaptable slice 330 and, thus, can involve a slice capability message exchanges 340 with the network 310. The slice capability message exchanges 340 can result in an update to the slice configuration information 322. For instance, the intermediate device 320 can request a service type (e.g., eMBB) to be added to the slice and can receive back a confirmation that the service type has been added. The update can indicate that the service type is now available via the slice. The intermediate device 320 can then render this service type available to an end device (e.g., the end device can use an eMBB slice of the network 310).

The above slice-related functions can be implemented at the OS level of the intermediate device 320 or some other level (e.g., in middleware). Further, the above slice-related functions can be enabled by a subscription with the network 310. Here, the subscription can indicate that an adaptable slice is requested and can identify that the adaptable slice is to be configured for the intermediate device 320. The subscription may, but need not, identify the end devices. Further, the subscription may identify any or a combination of the maximum number of end devices, the end device types, the network access types, the endpoint application types, the maximum number of slices, the maximum number a slice can be portioned, a set of service types, and/or other slice properties.

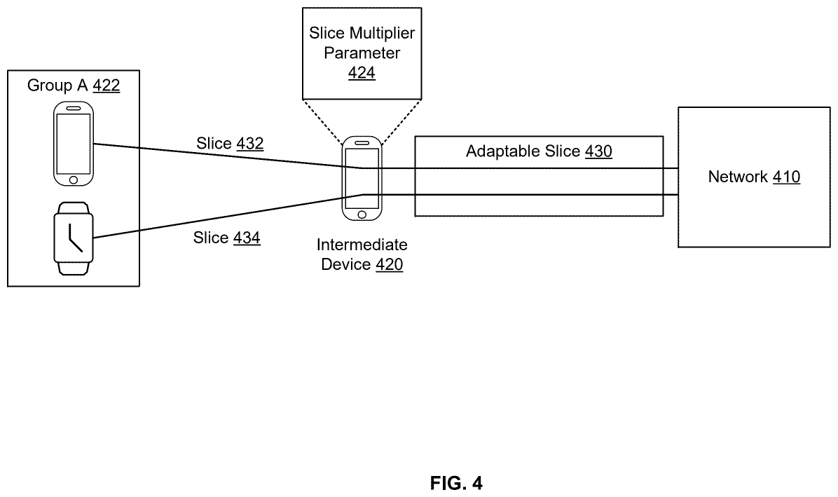

FIG. 4 illustrates an example of adaptive network slicing that is based on pre-associations between end devices and slices, in accordance with some embodiments. An adaptable slice 430 with a network 410 is configured for an intermediate device 420, similar to the approach in FIG. 3. The similarities are not repeated herein in the interest of brevity, but equivalently apply to the description of FIG. 4.

In an example of the pre-association, the subscription identifies the end devices (e.g., by including corresponding device identifiers, such as SIMs thereof). The subscription can also identify slice properties of the adaptable slice 430 (e.g., the requested service type(s) and/or other properties). In this case, each slice of the adaptable slice 430 is specific to one of the device identifiers and can have the same slice properties of the adaptable slice 430. The different slices can be configured for the intermediate device as part of the adaptable slice 430. Upon an end device connecting to the intermediate device 420 (e.g., based on an attachment procedure or a discovery procedure), the intermediate device 420 can activate a slice of the adaptable slice 430 for the end device. It is also possible that the intermediate device 420 may store a mapping between each slice and a corresponding device identifier. As such, upon an end device connecting to the intermediate device 420, the intermediate device 420 can look up the mapping by using the device identifier of the end device to determine the relevant slice that needs to be activated. Activating a slice can include signaling to the network 410 (e.g., a slice management function that may be part of the NSSF of the core network) that a status of the slice is to be changed (e.g., from deactivated to activated).

The network 410 can send slice configuration information to the intermediate device 420 to configure the intermediate device 420 such that to control or manage the use of the adaptable slice 430 by end devices. Various type of signaling to send slice configuration information can be possible, including using out of band and/or in band signaling that involve a non-access stratum or an access stratum. In an example, the slice configuration information includes a slice multiplier parameter 424 (and possibly the mapping). In this example, the slice configuration information represents a configuration for a single slice having a particular set of slice properties (e.g., an eMBB slice with a particular bandwidth or throughput and a particular latency). The slice multiplier parameter 424 indicates that the configuration can be replicated a number of times, where this number is equal to or smaller than the total number of pre-associated end devices. As such, the intermediate device 420 can configure and/or activate a first slice for a first device according to the configuration (e.g., a first eMBB slice with the particular bandwidth or throughput and the particular latency) and can replicate the same configuration for one or more end devices such as additional slices are configured and/or activated for these end devices up to the allowable number of times. In a way, the number of slices of the adaptable slice 430 can be multiplied over time up to the allowable number. Conversely, if an end device is not using a slice or is no longer connected to the intermediate device 420, that slice can be deactivated.

In an example, with the slice multiplier 424, the intermediate device 420 activates a new slice of the same configuration every time a new end device connects to the intermediate device 420. The intermediate device 420 can bring up to “N” number of slices based on active end devices. “N” can be equal to or smaller than the allowable number.

FIG. 4 illustrates a simple scenario of a group A 422 of two end devices (similar to the group A 232 of FIG. 2). Say that the adaptable slice 430 supports XRXR and two (or some other number of) end devices. Upon a first end device of the group A 422 being connected to the intermediate device 420, the intermediate device 420 activates a first slice 432 of the adaptable slice 430 (e.g., an XR slice) for the first end device. Upon a second end device of the group A 422 being connected to the intermediate device 420, the intermediate device 420 activates a second slice 434 of the adaptable slice 430 (e.g., an XR slice) for the second end device. Here, the first slice 432 and the second slice 434 have the same slice configuration. The intermediate device 420 can route first traffic from the first end device to the first slice 432 and second traffic from the second end device to the second slice 434.

The activation for each end device can involve multiple steps. These steps can include any or all of the following. The intermediate device 420 can connect with an end device (e.g., as part of or after an attachment procedure and/or a discovery procedure) and determine the device identifier thereof. The intermediate device 420 can determine, from the slice configuration information, if a slice is configured for a corresponding device identifier. If so, the intermediate device 420 may, but need not, cause the cause the end device to present information, on a user interface of the end device, indicating that a slice is available. Via the user interface, the intermediate device 420 can request whether the slice is to be used. If input is received via the user interface confirming that the slice is to be used, the activation can continue. Otherwise, the activation can stop. Assuming that the activation is to continue, the intermediate device 420 may, but need not, identify the slice (e.g., based on the mapping information) and can signal the network 410 to activate the slice (as identified or, otherwise, any of the configured slices). The network 410 can send a response to the intermediate device 420 indicating that the slice has been activated. The intermediate device 420 can cause the end device to present, on the user interface, an indication that the slice has been activated. If no slice is configured for the device identifier, the intermediate device 420 may not activate the slice and may cause the end device to present, on the user interface, information indicating that no slice is available.

In this approach, no device initiated signaling is needed to modify an end device slice configuration. An operator of the network 410 can provide different slicing plans to consumers depending upon how many end devices need to be supported in their subscriptions. However, partial slice usage may not be possible once the slice configuration information is defined. For example, imagine a scenario where all of a slice bandwidth is not needed for and end device to maintain QoS, but a part of the bandwidth if guaranteed could help the end device achieve its desired QoS. In this case, the remaining part of the bandwidth may not be used by another end device. Approaches in the next figures enable the partial use.

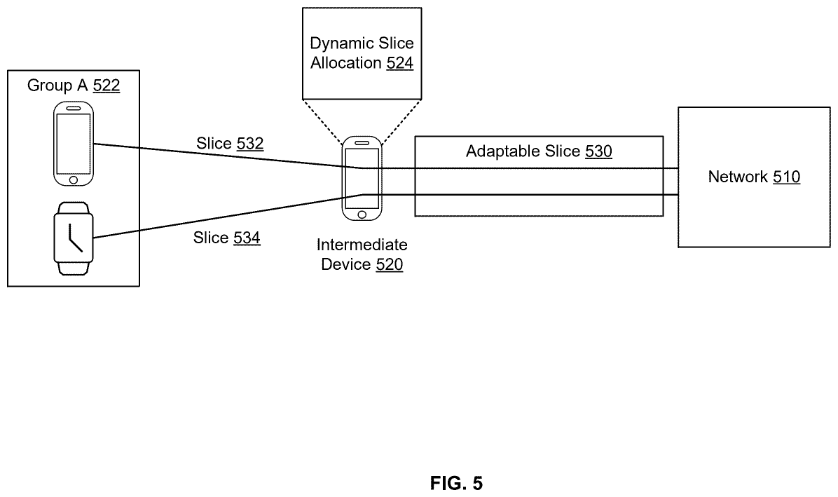

FIG. 5 illustrates an example of adaptive network slicing that dynamically allocates end devices to slices, in accordance with some embodiments. An adaptable slice 530 with a network 510 is configured for an intermediate device 520, similar to the approach in FIG. 3. The similarities are not repeated herein in the interest of brevity, but equivalently apply to the description of FIG. 5.

For the adaptive network slicing, the subscription need not identify the end devices. Instead, the subscription can identify a total number of slices of the adaptable slice 530, where this total number can represent a maximum number of end devices for which the adaptable slice 530 can be used and/or the maximum number of applications executing on end devices for which the adaptable slice 530. The subscription can also identify properties of the adaptable slice 530 (e.g., the requested service type(s) and/or other properties).

The network 510 can send slice configuration information to the intermediate device 520 to configure the intermediate device 520 such that to control or manage the use of the adaptable slice 530 by end devices. In an example, the slice configuration information enables dynamic slice allocation 524 by the intermediate device 520. Different types of dynamic slice allocations are possible. In all these types, no end device-to-subscription pre-association exist.

In one example, multiple slices may be pre-configured as part of the adaptable slice 530. These slices may have the same slice configuration (e.g., all be XR slices with the same throughput and latency) or with different slices configurations (e.g., some may be XR slices, others may be eMBB slices, and/or the XR slices may have different throughputs and latencies). Regardless, upon an end device connecting to the intermediate device 520 (e.g., as part of or after an attachment procedure and/or a discovery procedure), the intermediate device 520 can activate one of the slices for the end device. The activation can follow similar steps as those described in FIG. 4 (the similarities are not repeated herein, but equivalently apply) except that no mapping is used. Further, if different slice types and/or properties are available, the intermediate device 520 can select the relevant slice that needs to be activated. The selection can be based on the type of the end device and/or the type of the application executing on the end device. The end device type and/or application type can indicate a particular slice type or properties that may be needed. The intermediate slice can select the slice to activate by matching its type and/or properties with the needed type and/or properties. The slice configuration information can include a description, per slice, of the slice type and/or properties to enable the matching.

In another example, the slices may not be configured. Instead, upon the end device's connection with the intermediate device 520, the intermediate device 520 can configure and activate a slice for the end device as part of the adaptable slice 530. Here, the intermediate device 520 can determine the needed slice type and/or slice properties based on the end device type and/or application type (or by prompting the end device to present, on a user interface, a request for this information and receiving the information as input at the user interface). The intermediate device 520 can signal the network 510 to configure and activate the slice as part of the adaptable slice 530. The signaling need not identify the end device.

In the above two examples, assume that the slices have the same slice configuration. The subscription indicates a maximum number of slices that can have that slice configuration and that can be used. Here, the intermediate device 520 can configure and/or activate a first slice for a first device according to the configuration (e.g., a first XR slice) and can replicate the same configuration for one or more end devices such as additional slices are configured and/or activated for these end devices up to the maximum number. In a way, the number of slices of the adaptable slice 530 can be multiplied over time up to the maximum number. Conversely, if an end device is not using a slice or is no longer connected to the intermediate device 520, that slice can be terminated or deactivated.

In yet another example, a slice of the adaptable slice 530 may already be pre-configured or configured per the above two examples. Upon the end device's connection with the intermediate device 520, the intermediate device 520 can determine that the slice is to be modified (e.g., a property thereof is to be changed, such as to add a new service type, to change a traffic descriptor, to change a route selection, to change throughput, to change latency, to change a quality of service (QOS) of the slice, etc.). The intermediate device 520 can then signal the network 510 to update the slice configuration and can receive back a confirmation that the change has been performed. This confirmation can include updated slice configuration information. Thereafter, the intermediate device 520 can allocate the slice to the end device. If this slice is to be activate, an activation procedure similar to the above procedure can be used. Conversely, if the end device is no longer using the slice or is no longer connected to the intermediate device 520, the intermediate device 520 can signal the network 510 to update the current slice configuration accordingly.

In an example, with the dynamic slice 524, the network 510 can configure one single adaptable slice 530 for the intermediate device 520 to enable slicing for all end devices. The intermediate device can bring up “X” slices (up to “N”—the subscription's maximum number) based on active end devices.

FIG. 5 illustrates a simple scenario of a group A 522 of two end devices (similar to the group A 232 of FIG. 2). Say that the adaptable slice 530 supports XR and a maximum number of two (or maybe greater) number of end devices. Upon a first end device of the group A 522 being connected to the intermediate device 520, a first slice 532 of the adaptable slice 530 (e.g., an XR slice) becomes usable to the first end device. Upon a second end device of the group A 522 being connected to the intermediate device 520, a second slice 534 of the adaptable slice 530 (e.g., an XR slice) becomes usable to the second end device. Here, the first slice 532 and the second slice 534 may, but need not, have the same slice configuration. The intermediate device 520 can route first traffic from the first end device to the first slice 532 and second traffic from the second end device to the second slice 534.

In another illustration, upon the first end device of the group A 522 being connected to the intermediate device 520, the first slice 532 of the adaptable slice 530 (e.g., an XR slice) becomes usable to the first end device. Upon the second end device of the group A 522 being connected to the intermediate device 520, the intermediate device 520 can signal the network 410 to change a property of the first slice 532 (e.g., to increase the throughput of the XR slice, to change its QoS, or to add a new service type to the first slice 532 such that the first slice 532 is suitable for XR and eMBB). Here, the second slice 534 need to be configured or activated. The intermediate device 520 can aggregate the first traffic from the first end device and second traffic from the second end device, resulting in aggregated traffic. The aggregated traffic is sent using the first slice 532 (upon being modified).

In the above examples, from the network's 510 perspective, all end devices are masked and abstracted as a single device passing through the intermediate device 520 with variable slice properties being applied dynamically.

Generally, data security can be implemented, whereby the adaptable slice 530 can be associated with a set of encryption keys to use to encrypt and/or decrypt the traffic exchange via the adaptable slice 530. Network can leverage 3GPP defined packet data convergence protocol (PDCP) level security mechanisms to protect slice data between an end device and the network 510 (e.g., a base station thereof). Optionally, the network 510 can indicate that a public encryption key is to be used for traffic to the network. This traffic is encrypted using the public encryption key. The corresponding private encryption key is a key of the network 510. As such, only the network 510 can decrypt the encrypted data (unless the private encryption key is compromised). Conversely, the intermediate device 520 can indicate that a public encryption key is to be used for traffic to the ecosystem (e.g., to the intermediate device 520 and any of the associated end devices). This traffic is encrypted using the public encryption key. The corresponding private encryption key is a key of the ecosystem. As such, only an end device of the ecosystem having the private encryption key can decrypt the encrypted data (unless the private encryption key is compromised), or the intermediate device 520 cand decrypt the data using the private key and send the decrypted data (possibly encrypted with a different key) to the end device. In both cases, the slice configuration information can indicate the network's public encryption key. The intermediate device 520 can distribute this key to any of the end devices. Further, the intermediate device 520 can send the ecosystem's public key and/or its public key to the network 510.

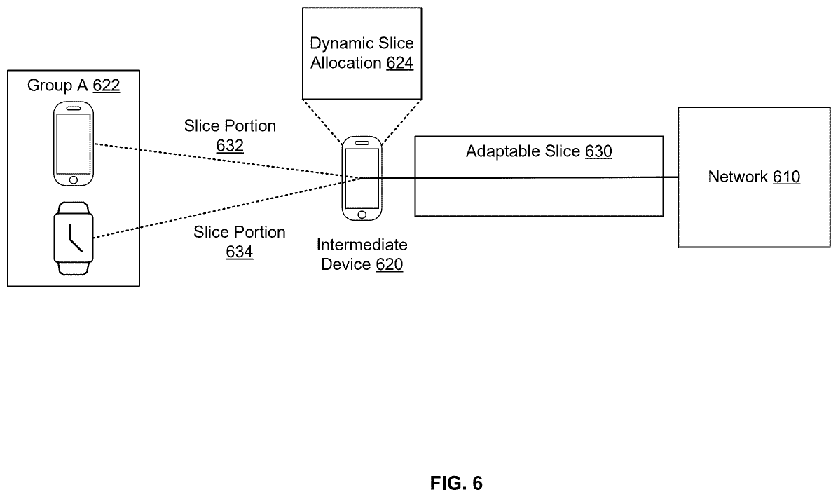

FIG. 6 illustrates an example of adaptive network slicing that dynamically allocates end devices to portions of a slice, in accordance with some embodiments. An adaptable slice 630 with a network 610 is configured for an intermediate device 620, similar to the approach in FIG. 3. The similarities are not repeated herein in the interest of brevity, but equivalently apply to the description of FIG. 6.

For the adaptive network slicing, the subscription need not identify the end devices. Instead, the subscription can indicate that the adaptable slice 630 can be dynamically updated. The update can include changing a service type (e.g., to add or remove a service type available via the adaptable slice 630) and/or changing a slice property (e.g., to increase or decrease a throughput and/or change a QoS).

The network 610 can send slice configuration information to the intermediate device 620 to configure the intermediate device 620 such that to control or manage the use of the adaptable slice 630 by end devices. In an example, the slice configuration information enables dynamic slice allocation 624 by the intermediate device 620. Here, the dynamic slice allocation 624 enables partitioning of the adaptable slice 630 over time.

In an example, the adaptable slice 630 is configured for the intermediate device 630 with particular set of service types and slice properties. A group A 622 of two end devices (similar to the group A 232 of FIG. 2) is associated with the intermediate device 620. Upon a first end device of the group A 622 connecting to the intermediate device 620 (e.g., as part of or after an attachment procedure and/or a discovery procedure), the intermediate device 620 can allocate a first portion of the adaptable slice 630 (shown as slice portion 632) to the first end device. Upon a second end device of the group A 622 connecting to the intermediate device 620 (e.g., as part of or after an attachment procedure and/or a discovery procedure), the intermediate device 620 can allocate a second portion of the adaptable slice 630 (shown as slice portion 634) to the second end device. Allocating a slice portion to end device can represent the intermediate device using particular service type(s) and slice properties of the configured set (e.g., half, or some percentage, of the bandwidth of an XR slice) for the traffic to and from the end device.

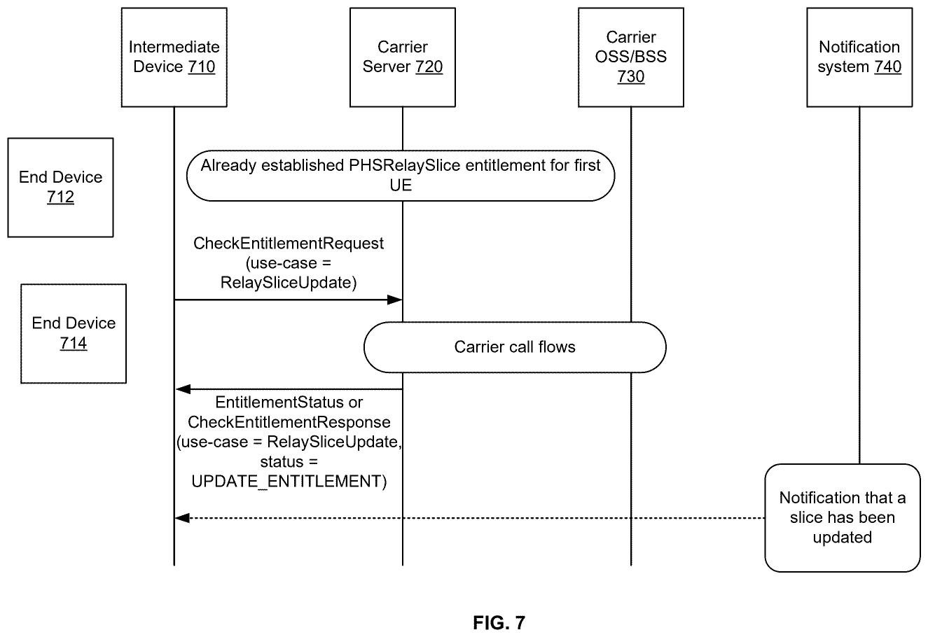

FIG. 7 illustrates an example of signaling between an intermediate device and a network for adaptive slicing, in accordance with some embodiments. The signaling can be used to update a configuration of an adaptable slice, such as any of the adaptable slices described herein above. The signaling can be out of band, such as via a non-access stratum or an over the top channel.

As illustrates, an intermediate device 710 has established a slice with a network for a first end device 712 (shown in FIG. 7 as an “already established PHSRelaySlice entitlement for first UE)”. The network includes a carrier server 720 (e.g., an entitlement server), a carrier operations support system (OSS) and/or business support system (BSS) 730 (including possibly a base station), and a notification system 740 (among other components, such as a core network). The slice can with the core network via the base station 730.

Upon a second end device 714 connecting to the intermediate device 710 (e.g., as part of or after an attachment procedure and/or a discovery procedure), the intermediate device can signal the carrier server 720 that an update to the slice is needed. The update can indicate the change to the slice property. The signaling is shown as “CheckEntitlementRequest (use-case=RelaySliceUpdate)” in FIG. 7. This request can enable an authentication of the intermediate device, while also requesting the update. The “RelaySliceUpdate” can describe the change. The carrier server 720 can initiate one or more carrier call flows, that may be internal to the network and that results in the update being made. Here, at least a network slice function of the core network is updated accordingly. The entitlement server can send a response indicating a status of the update (shown in FIG. 7 as “EntitlementStatus or CheckEntitlementResponse (use-case=RelaySliceUpdat, status=UPDATE ENTITLEMENT)”). Upon completion of these flows, the notification system 740 sends a notification to the intermediate device 710 that the slice has been updated. This notification can include updated slice configuration information or cause the intermediate device 710 to update its current slice configuration information.

The above update is illustrated as including requesting a change to slice properties of a slice when an additional device needs to use the slice. However, the embodiments are not limited as such. For example, the update can be to configure an additional slice having the same slice properties as the slice or different slice properties. For example, the “use-case” can be set to request a new slice, and the notification can indicate that the new slice has been added.

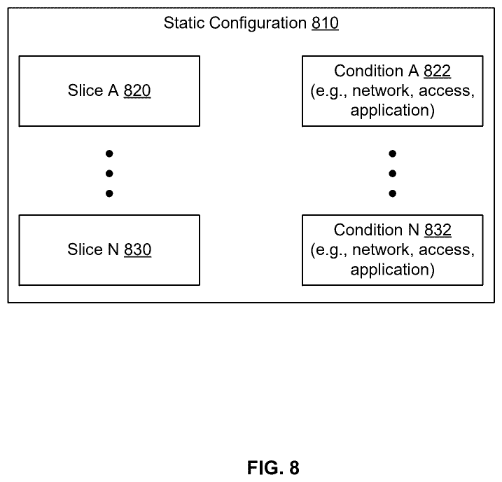

FIG. 8 illustrates an example of a static configuration 810 for adaptive network slicing, in accordance with some embodiments. The static configuration 810 can be sent, as part of slice configuration information to an intermediate device, such as any of the intermediate devices described herein above. An update process can be followed and can be controlled by the network to change the static configuration 810 to a new configuration upon a change to the subscription.

As illustrates, the static configuration 810 can identify a number of slices (shown as slice A 820 to slice N 830) and/or configurations thereof. For each of the slices (or a group of such slices), the static configuration 810 can indicate a set of conditions that, when satisfied, the slice (or a slice of the group) can be used (e.g., configured, or if pre-configured, activated). The conditions are illustrated as condition A 822 to condition N 832. For instance, condition A 822 corresponds to slice A 820, whereas condition N 832 corresponds to slice N 830. The conditions may be different and can relate to a network, a network access, and/or an application. The network can correspond to the network to which the end device connects. The network access can correspond to the type of access to the network. The application can correspond to the application executing on the end device and for which the slice would be used.

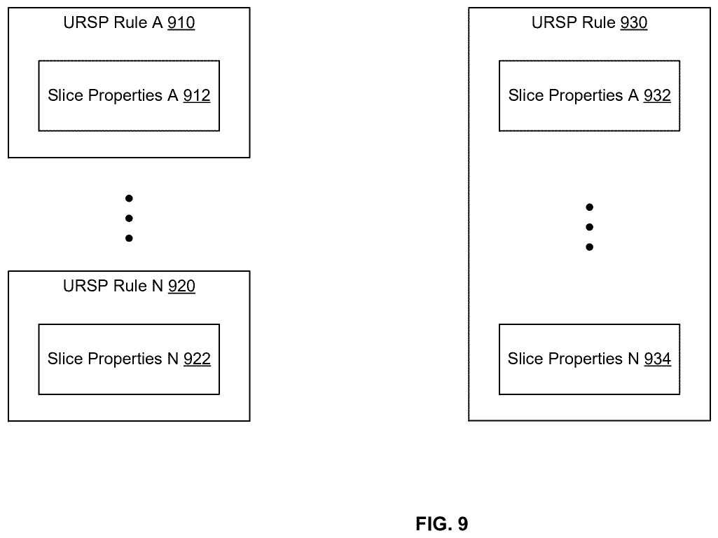

FIG. 9 illustrates an example of user equipment routing selection Policy (URSP) rules for adaptive network slicing, in accordance with some embodiments. rules can be signaled and updated via a non-access stratum. An intermediate device, such as any of the above intermediate devices, can use the URSP rules to identify a slice to use. Different approaches to the URSP rules are possible. The left side of FIG. 9 illustrates one type, whereas the right side of FIG. 9 illustrates a different type.

As shown on the left side, a URSP rule can be defined per slice. Each URSP rule can include slice properties indicating, among other things, a traffic descriptor and a route selection descriptor list. For instance, a URSP rule A 910 can be defined for a first slice and can include slice properties A 912, and so on, up to a URSP rule 920 defined for an N^{th} slice and include slice properties N 922. One or more slice properties can vary from one URSP rule to another URSP rule.

As shown on the right side, a single URSP rule 930 is defined and can include multiple sets of slice properties (shown as slice properties A 932, and so on, up to slice properties N 934). Each set can be specific to a slice or usable for one of many service types available via the slice.

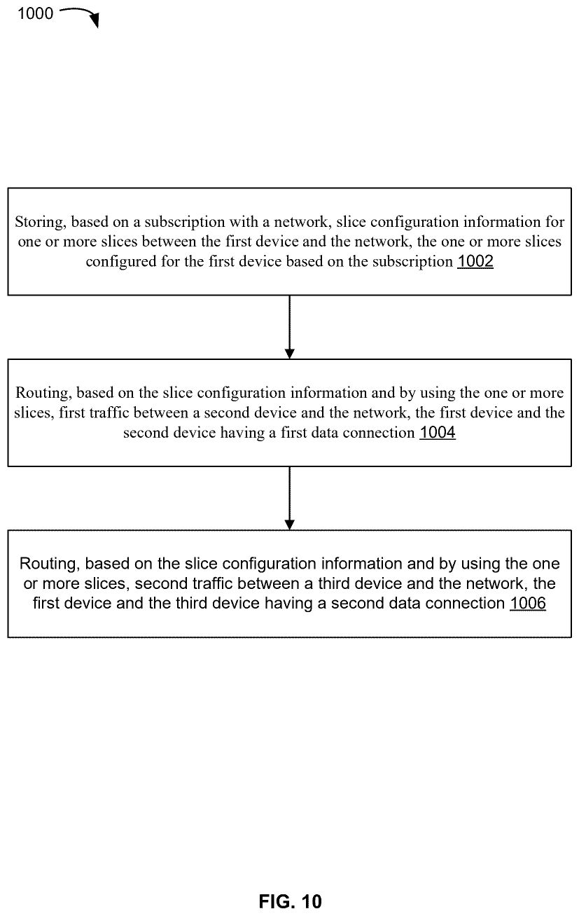

FIG. 10 illustrates an example of an operational flow/algorithmic structure 1000 for adaptive network slicing, in accordance with some embodiments. The operational flow/algorithmic structure 1000 can be implemented by a first device (e.g., performed by an intermediate device such as any of the intermediate devices described herein above, or by components thereof including, for example, an apparatus of the intermediate device, where the apparatus includes processing circuitry). In some embodiments, the operational flow/algorithmic structure 1000 may be implemented by executing instructions stored in a tangible, non-transitory, computer-readable storage medium, such as a memory of the first device. While the operational flow/algorithmic structure 1000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1000 includes, at 1002, storing, based on a subscription with a network, slice configuration information for one or more slices between the first device and the network, the one or more slices configured for the first device based on the subscription. The one or more slices can correspond to any of the adaptable slices described herein above. The slice configuration information can be received from the network and can configure the first device to manage or control the use of the adaptable slices by end devices. For instance, the slice configuration information can indicate a slice multiplier parameter, such as the one described in FIG. 4, or can enable a dynamic slice allocation 524 and/or 624 of FIGS. 5 and 6. The slice configuration information can also enable the intermediate device to perform various signaling with the network, including the signaling described in FIGS. 7-9 for an entitlement exchange, a static configuration exchange, and/or URSP rules exchange.

In an example, the operational flow/algorithmic structure 1000 includes, at 1004, routing, based on the slice configuration information and by using the one or more slices, first traffic between a second device and the network, the first device and the second device having a first data connection. For instance, the second device may be an endpoint that belongs to the same account as the intermediate device and that may be a node of an ecosystem.

In an example, the operational flow/algorithmic structure 1000 includes, at 1006, routing, based on the slice configuration information and by using the one or more slices, second traffic between a third device and the network, the first device and the third device having a second data connection. For instance, the third device may be another endpoint that belongs to the same account and that may be another node of the ecosystem. Two different slices can be used and/or different portions of the same slice can be used for the first and second traffic as described in FIGS. 4-6.

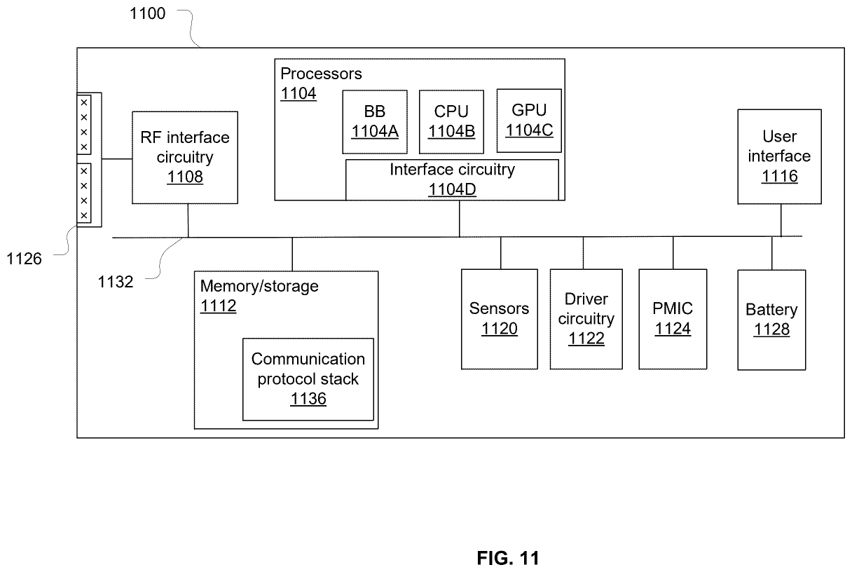

FIG. 11 illustrates a device 1100, in accordance with some embodiments. The device 1100 may be similar to and substantially interchangeable with the intermediate devices described herein above. In particular, the device 1100 can store slice configuration information for an adaptable slice. Based on this information, the device 100 can manage use of the adaptable slice by one or more end devices connected to the device 1100.

In an example, the device 1100 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices, spatial computer, router, gateway, device hub.

The device 1100 may include processors 1104, RF interface circuitry 1108, memory/storage 1112, user interface 1116, sensors 1120, driver circuitry 1122, power management integrated circuit (PMIC) 1124, and battery 1128. The components of the device 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the device 1100. However, some of the components shown may be omitted, additional components may be present, and different arrangements of the components shown may occur in other implementations.

The components of the device 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry such as baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the device 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1104A may also access group information 1124 from memory/storage 1112 to determine search space groups in which a number of repetitions of a PDCCH may be transmitted.

The memory/storage 1112 may include any type of volatile or non-volatile memory that may be distributed throughout the device 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1108 may include transceiver circuitry and a radio frequency front module (RFEM) that allows the device 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1124 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1124.

In various embodiments, the RF interface circuitry 1108 may be configured to transmit/receive signals in a manner compatible with NR access technologies.

The antenna 1124 may include a number of antenna elements that each convert electrical signals into radio waves to travel through the air and to convert received radio waves into electrical signals. The antenna elements may be arranged into one or more antenna panels. The antenna 1124 may have antenna panels that are omnidirectional, directional, or a combination thereof to enable beamforming and multiple input, multiple output communications. The antenna 1124 may include microstrip antennas, printed antennas fabricated on the surface of one or more printed circuit boards, patch antennas, phased array antennas, etc. The antenna 1124 may have one or more panels designed for specific frequency bands including bands in FR1 or FR2.

The user interface circuitry 1116 includes various input/output (I/O) devices designed to enable user interaction with the device 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the device 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the device 1100, attached to the device 1100, or otherwise communicatively coupled with the device 1100. The driver circuitry 1122 may include individual drivers allowing other components to interact with or control various input/output (I/O) devices that may be present within, or connected to, the device 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the device 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the device 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the device 1100 may power down for brief intervals of time and thus save power. If there is no data traffic activity for an extended period of time, then the device 1100 may transition off to an RRC_Idle state, where it disconnects from the network and does not perform operations, such as channel quality feedback, handover, etc. The device 1100 goes into a very low power state and it performs paging where again it periodically wakes up to listen to the network and then powers down again. The device 1100 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1128 may power the device 1100, although in some examples the device 1100 may be mounted deployed in a fixed location, and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

### EXAMPLES

In the following sections, further exemplary embodiments are provided.

Example 1 includes a method implemented on a first device, the method comprising: storing, based on a subscription with a network, slice configuration information for one or more slices between the first device and the network, the one or more slices configured for the first device based on the subscription; routing, based on the slice configuration information and by using the one or more slices, first slice traffic between a second device and the network, the first device and the second device having a first data connection; and routing, based on the slice configuration information and by using the one or more slices, second slice traffic between a third device and the network, the first device and the third device having a second data connection.

Example 2 includes a method implement on a first device, the method comprising: causing, by using one or more slices based on slice configuration information, first slice traffic to be routed between a second device and a network, the first device and the second device having a first data connection, the one or more slices configured for the device based on a subscription with the network; and causing, by using the one or more slices based on the slice configuration information, second slice traffic to be routed between a third device and the network, the first device and the third device having a second data connection.

Example 3 includes the method of any preceding example 1-2, wherein the first device, the second device, and the third device are associated with a same account identifier, and wherein the subscription is associated with the same account identifier.

Example 4 includes the method of any preceding example 1-3, wherein the second device is pre-associated with a first slice of the one or more slices based on the subscription.

Example 5 includes the method of example 4, further comprising: activating, based on the first data connection being established, a first slice of the one or more slices, wherein the first slice traffic is routed by using the first slice.

Example 6 includes the method of any preceding example 1-5, wherein the third device is pre-associated with a second slice of the one or more slices based on the subscription, and wherein the first slice traffic is routed by using the first slice while the second slice traffic is routed by using the second slice.

Example 7 includes the method of any preceding example 1-6, wherein the first device is a relay device, wherein each one of the second device and the third device is an end device, wherein the slice configuration information indicates that “N” slices are configured for the relay device, wherein the method further comprises: determining, by the relay device, that a first slice of the “N” slices is to be used for the first slice traffic; and determining, by the relay device, that a second slice of the “N” slices is to be used for the second slice traffic.

Example 8 includes the method of any preceding example 1-7, wherein the slice configuration information indicates a slice property for a slice of the one or more slices, wherein the slice property includes a quality of service (QOS) of the slice, and wherein the first slice traffic is routed by using the slice based on the QoS.

Example 9 includes the method of any preceding example 1-2, wherein the second device is unassociated with the subscription, and wherein the one or more slices are configured independently of the second device.

Example 10 includes the method of any preceding example 1-9, wherein the one or more slices include a first slice, and wherein the first slice traffic and the second slice traffic are routed by using the first slice.

Example 11 includes the method of example 10, wherein the first slice traffic is routed by using a first portion of the first slice, and wherein the second slice traffic is routed by using a second portion of the first slice.

Example 12 includes the method of any preceding example 1-11, wherein the slice configuration information indicates a slice property for a slice of the one or more slices, wherein the first slice traffic is routed by using the slice based on the slice property, and wherein the method further comprises: indicating, to the network based on the second data connection being established, a change to the slice property; and storing updated slice configuration information indicating the change to the slice property, wherein the second slice traffic is routed by using the slice based on the updated slice configuration information.

Example 13 includes the method of any preceding example 1-11, wherein the slice configuration information indicates a first slice property for a first slice of the one or more slices and a second slice property for a second slice of the one or more slices, wherein the first slice and the second slice are configured independently of the second device and the third device, and wherein the method further comprises: activating, based on the first data connection being established and the first slice property, the first slice, wherein the first slice traffic is routed by using the first slice.

Example 14 includes the method of any preceding example 1-13, further comprising: causing an encryption key associated with the one or more slices and indicated by the slice configuration information to be sent to the second device, wherein the first slice traffic is encrypted based on the encryption key.

Example 15 includes the method of any preceding example 1-14, further comprising: generating aggregated slice traffic by aggregating the first slice traffic and the second slice traffic, wherein the first slice traffic and the second slice traffic are routed by routing the aggregated slice traffic using a same slice of the one or more slices.

Example 16 includes the method of any preceding example 1-15, further comprising: sending a slice update request to a server of the network, the slice update request indicating a change to the slice configuration information; and storing updated slice configuration information that is sent from the network based on the slice update request, wherein the updated slice configuration information indicates a change to the one or more slices.

Example 17 includes the method of any preceding example 1-15, further comprising: storing one or more user equipment routing selection policy (URSP) rules corresponding to the one or more slices and indicating at least one of: different routing descriptors or route selection descriptor lists.

Example 18 includes the method of any preceding example 1-15, wherein the slice configuration information indicates a static configuration for the one or more slices based on at least one of the network, an access to the network, or an application.

Example 19 includes the method of any preceding example 1-18, further comprising: causing the second device to present a request of whether to use the one or more slices; and receiving, from the second device, an indication that the one or more slices are to be used, wherein the one or more slices are used for the first slice traffic based on the indication.

Example 20 includes a user equipment (UE) or an apparatus comprising: one or more processors; and one or more memory storing instructions that, upon execution by the one or more processors, configure the UE or the apparatus to perform a method described in or related to any of the preceding examples.

Example 21 includes one or more computer-readable media storing instructions that, when executed on a user equipment (UE) or an apparatus, cause the UE or the apparatus to perform operations comprising one or more elements of a method described in or related to any of the preceding examples.

Example 22 includes an apparatus comprising means to perform one or more elements of a method described in or related to any of the preceding examples.

Example 23 includes one or more non-transitory computer-readable media comprising instructions to cause an apparatus, upon execution of the instructions by one or more processors of the apparatus, to perform one or more elements of a method described in or related to any of the preceding examples.

Example 24 includes an apparatus comprising logic, modules, or processing circuitry configured to perform one or more elements of a method described in or related to any of the preceding examples.

Example 25 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method implemented on a first device, the method comprising:
storing, based on a subscription with a network, slice configuration information for one or more slices between the first device and the network, the one or more slices configured for the first device based on the subscription;
routing, based on the slice configuration information and by using the one or more slices, first slice traffic between a second device and the network, the first device and the second device having a first data connection; and
routing, based on the slice configuration information and by using the one or more slices, second slice traffic between a third device and the network, the first device and the third device having a second data connection.

2. The method of claim 1, wherein the first device, the second device, and the third device are associated with a same account identifier, and wherein the subscription is associated with the same account identifier.

3. The method of claim 1, wherein the second device is pre-associated with a first slice of the one or more slices based on the subscription.

4. The method of claim 3, further comprising:
activating, based on the first data connection being established, a first slice of the one or more slices, wherein the first slice traffic is routed by using the first slice.

5. The method of claim 3, wherein the third device is pre-associated with a second slice of the one or more slices based on the subscription, and wherein the first slice traffic is routed by using the first slice while the second slice traffic is routed by using the second slice.

6. The method of claim 1, wherein the first device is a relay device, wherein each one of the second device and the third device is an end device, wherein the slice configuration information indicates that “N” slices are configured for the relay device, wherein the method further comprises:
determining, by the relay device, that a first slice of the “N” slices is to be used for the first slice traffic; and
determining, by the relay device, that a second slice of the “N” slices is to be used for the second slice traffic.

7. The method of claim 1, wherein the slice configuration information indicates a slice property for a slice of the one or more slices, wherein the slice property includes a quality of service (QOS) of the slice, and wherein the first slice traffic is routed by using the slice based on the QoS.

8. An apparatus comprising:
processing circuitry configured to be communicatively coupled with a receiver and a transmitter of a first device and to:
cause, by using one or more slices based on slice configuration information, first slice traffic to be routed between a second device and a network, the first device and the second device having a first data connection, the one or more slices configured for the device based on a subscription with the network; and
cause, by using the one or more slices based on the slice configuration information, second slice traffic to be routed between a third device and the network, the first device and the third device having a second data connection.

9. The apparatus of claim 8, wherein the second device is unassociated with the subscription, and wherein the one or more slices are configured independently of the second device.

10. The apparatus of claim 8, wherein the one or more slices include a first slice, and wherein the first slice traffic and the second slice traffic are routed by using the first slice.

11. The apparatus of claim 10, wherein the first slice traffic is routed by using a first portion of the first slice, and wherein the second slice traffic is routed by using a second portion of the first slice.

12. The apparatus of claim 8, wherein the slice configuration information indicates a slice property for a slice of the one or more slices, wherein the first slice traffic is routed by using the slice based on the slice property, and wherein the processing circuitry is further configured to:
indicate, to the network based on the second data connection being established, a change to the slice property; and
store updated slice configuration information indicating the change to the slice property, wherein the second slice traffic is routed by using the slice based on the updated slice configuration information.

13. The apparatus of claim 8, wherein the slice configuration information indicates a first slice property for a first slice of the one or more slices and a second slice property for a second slice of the one or more slices, wherein the first slice and the second slice are configured independently of the second device and the third device, and wherein the processing circuitry is further configured to:
activate, based on the first data connection being established and the first slice property, the first slice, wherein the first slice traffic is routed by using the first slice.

14. The apparatus of claim 8, wherein the processing circuitry is further configured to:
cause an encryption key associated with the one or more slices and indicated by the slice configuration information to be sent to the second device, wherein the first slice traffic is encrypted based on the encryption key.

15. The apparatus of claim 8, wherein the processing circuitry is further configured to:
generate aggregated slice traffic by aggregating the first slice traffic and the second slice traffic, wherein the first slice traffic and the second slice traffic are routed by routing the aggregated slice traffic using a same slice of the one or more slices.

16. One or more computer-readable storage media storing instructions that, upon execution by one or more processors of a first device, cause operations comprising:
storing, based on a subscription with a network, slice configuration information for one or more slices between the first device and the network, the one or more slices configured for the first device based on the subscription;
routing, based on the slice configuration information and by using the one or more slices, first slice traffic between a second device and the network, the first device and the second device having a first data connection; and
routing, based on the slice configuration information and by using the one or more slices, second slice traffic between a third device and the network, the first device and the third device having a second data connection.

17. The one or more computer-readable storage media of claim 16, wherein the operations further comprise:
sending a slice update request to a server of the network, the slice update request indicating a change to the slice configuration information; and
storing updated slice configuration information that is sent from the network based on the slice update request, wherein the updated slice configuration information indicates a change to the one or more slices.

18. The one or more computer-readable storage media of claim 16, wherein the operations further comprise:
storing one or more user equipment routing selection policy (URSP) rules corresponding to the one or more slices and indicating at least one of: different routing descriptors or route selection descriptor lists.

19. The one or more computer-readable storage media of claim 16, wherein the slice configuration information indicates a static configuration for the one or more slices based on at least one of the network, an access to the network, or an application.

20. The one or more computer-readable storage media of claim 16, wherein the operations further comprise:
causing the second device to present a request of whether to use the one or more slices; and
receiving, from the second device, an indication that the one or more slices are to be used, wherein the one or more slices are used for the first slice traffic based on the indication.
